(19) United States
(12) Patent Application Publication
(10) Pub. No.: US 2008/0202922 A1
(43) Pub. Date: Aug. 28, 2008

(54) HYBRID ELECTRO-DEPOSITION OF SOFT MAGNETIC COBALT ALLOY FILMS

(76) Inventors: Ting Zhong, Tigard, OR (US); Arnel M. Fajardo, Beaverton, OR (US); Chang-Min Park, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/678,056

(22) Filed: Feb. 22, 2007

(51) Int. Cl. C05B 9/00

(52) U.S. Cl. 204/273; 205/89

(57) ABSTRACT

A hybrid electro-deposition process for soft magnetic cobalt alloy films comprises providing a plating bath that includes cobalt and a reducing agent, providing a cobalt-containing anode in the plating bath coupled to a power supply, providing a substrate in the plating bath coupled to the power supply, wherein the substrate functions as a cathode, applying a magnetic field across the plating bath, and applying an electrical current to the plating bath by way of the power supply to cause the cobalt to deposit onto the substrate and form a soft magnetic film.

### BACKGROUND

In the manufacture of integrated circuit components, deposition processes such as electroless plating have been used to deposit layers or films of various metals. Electroless plating, as will be known to those of skill in the art, is a metal deposition process in which the metal begins in solution and a controlled chemical reduction reaction is used to deposit the metal onto a substrate. The electroless process is autocatalytic as the metal being deposited catalyzes the chemical reduction reaction without the need for an external electric current. Electroless plating is a selective deposition and occurs at activated locations on the substrate surface, i.e., locations that have a nucleation potential for an electroless plating solution.

Unfortunately, electroless deposition processes have limited manufacturing capability when used to produce soft magnetic films of cobalt or cobalt alloys. The plating rate for such a process tends to be unacceptably slow and the electroless plating bath tends to have a relatively short lifetime. These constraints provide exceptionally difficult challenges to overcome when used in high volume manufacturing processes.

Accordingly, improved methods of forming soft magnetic cobalt or cobalt alloy films are needed.

### BRIEF DESCRIPTION OF THE DRAWINGS

FIG. 1 is a plating cell constructed in accordance with an implementation of the invention.

FIG. 2 is a method of forming a soft magnetic cobalt alloy film in accordance with an implementation of the invention.

FIG. 3 is an alternate view of the plating cell of FIG. 1.

### DETAILED DESCRIPTION

Described herein are systems and methods of depositing a soft magnetic cobalt alloy film using a hybrid electro-deposition process. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Implementations of the invention provide a hybrid electro-deposition process that combines aspects of a conventional electroplating process with aspects of a conventional electroless deposition process. For example, an external direct-current (DC), a pulse voltage, or a pulse current may be applied to an electroless deposition process. The hybrid electro-deposition process of the invention may be used to deposit soft magnetic films. The use of a hybrid electro-deposition process in accordance with implementations of the invention improves bath stability and the plating rate relative to conventional electroless plating processes.

In accordance with implementations of the invention, a plating bath is formed for use in the hybrid electro-deposition process. In at least one implementation, the plating bath may be an aqueous based solution that includes a reducing agent in solution and a metal in solution to be deposited, such as cobalt and one or more further metals to alloy with the cobalt. The use of a reducing agent makes the bath similar to a bath used in an electroless plating process. Since an electric field is applied to the bath, a lower bath operating temperature may be used relative to conventional electroless plating processes.

One specific recipe for a plating bath that may be used in the hybrid electro-deposition process of the invention is shown below in Table 1. While cobalt metal is used in the plating bath as shown in Table 1, some implementations may add alloying metals such as nickel (i.e., Ni²⁺ introduced by way of a nickel salt) and/or iron (i.e., Fe²⁺ introduced by way of an iron salt) to enhance the magnetic properties of the resultant cobalt alloy film, with corresponding modifications to the anode material (e.g., nickel and/or iron anodes). In various implementations of the invention, the anode may include one or more metals that include, but are not limited to, cobalt, iron, nickel, and platinized titanium.

TABLE 1

| Material | Concentration |
|---|---|
| Co²⁺ (introduced by a cobalt salt such as | 0.02 Molar (M) to 0.1M |
| cobalt sulfate or cobalt chloride) | |
| Citrate and/or Acetate | 0.1M to 0.5M |
| BO₃³⁻ (introduced by boric acid) | 0.5M to 1.0M |
| Dimethylamineborane (DMAB) | 0.02M to 0.1M |
| (Optiona)/WO₄²⁻ (introduced by a tungstate | 0.003M to 0.05M |
| salt or tungstic acid) | |
| (Optional) Ammonium Hypophosphite | 0.02M to 0.1M |
| (Optional) S10G Surfactant | 0–200 ppm |

Cobalt metal may be introduced to the plating bath through the addition of one or more cobalt salts that decompose in the aqueous solution to provide the Co²⁺ ions. Examples of cobalt salts that may be used in the plating bath include, but are not limited to, cobalt sulfate or cobalt chloride. The boron may be introduced through the addition of DMAB. The tungsten may be introduced to the plating bath through the addition of tungstate, for example in the form of tungstic acid, sodium tungstate, or ammonium tungstate, which decomposes in the aqueous solution to provide the WO₄²⁻ ions. The tungsten then interacts with the cobalt and one or more complexing agents and presents in the form of one or more metal-complex compounds. The citrate and/or the acetate function as complexing agents. In some implementations, tartrate may be added as a complexing agent. The S10G surfactant is available from Arch Chemicals, Inc. of Norwalk, Conn.

In implementations of the invention, the plating bath may be maintained at a pH level between around pH 7.3 and around pH 9.7. The pH level of the plating bath may be adjusted through the addition of chemicals such as tetramethylammonium hydroxide (TMAH), potassium hydroxide (KOH), ammonium hydroxide (NH₄OH), and boric acid. As will be described below, the temperature of the plating bath may be maintained at a temperature between around 22° C. and 40° C.

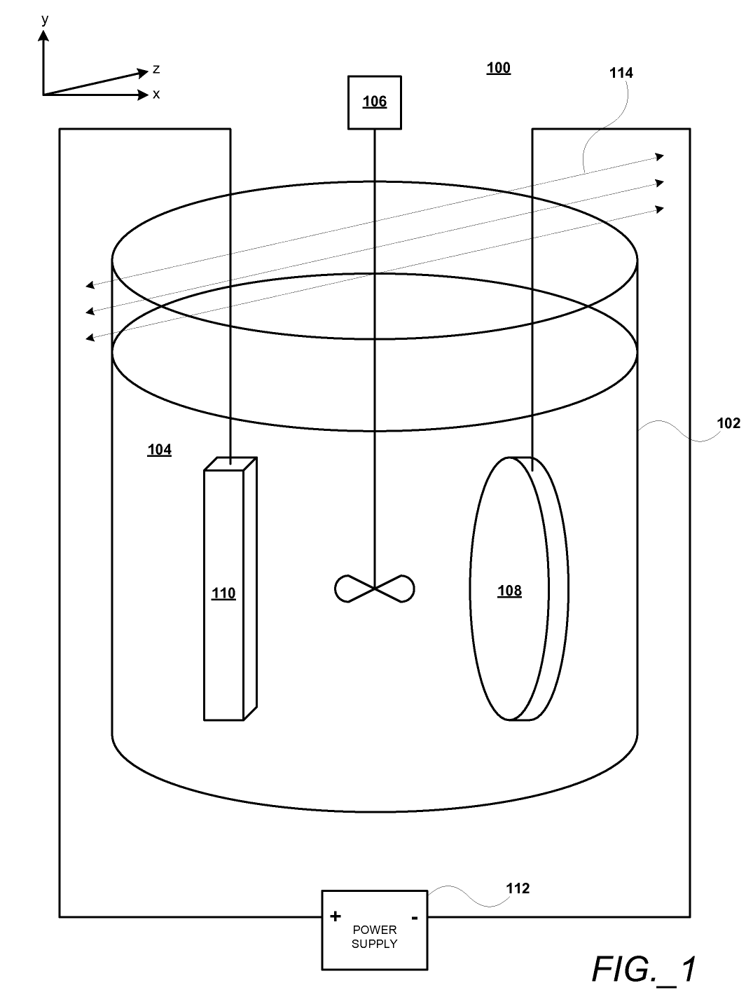

FIG. 1 illustrates an exemplary plating cell 100 for a hybrid electro-deposition process in accordance with an implementation of the invention. The plating cell 100 includes a reactor 102 that holds a plating bath 104. The plating bath 104 is a plating bath that can be used to deposit a soft magnetic cobalt alloy film; such a plating bath was described above. The plating bath 104 may be at room temperature or it may be heated slightly to a temperature around 40° C. An agitator 106 may be included in the reactor to stir the plating bath 104 to keep components of the plating bath suspended and to promote the electro-deposition process. A semiconductor wafer 108, upon which the soft magnetic cobalt-alloy film is to be deposited, is immersed into the plating bath 104 and functions as a cathode in the electro-deposition process of the invention. An anode 110 is also immersed in the plating bath 104. The anode 110 is generally formed of one or more metals that include, but are not limited to, cobalt, iron, nickel, and platinized titanium.

In accordance with implementations of the invention, the semiconductor wafer 108 (i.e., the cathode) and the anode 110 are connected to an external power supply 112. The power supply 112 provides a direct current (DC) to drive the electro-deposition process of the invention. In implementations of the invention, the power supply provides a current density of 5 mA/cm² or more.

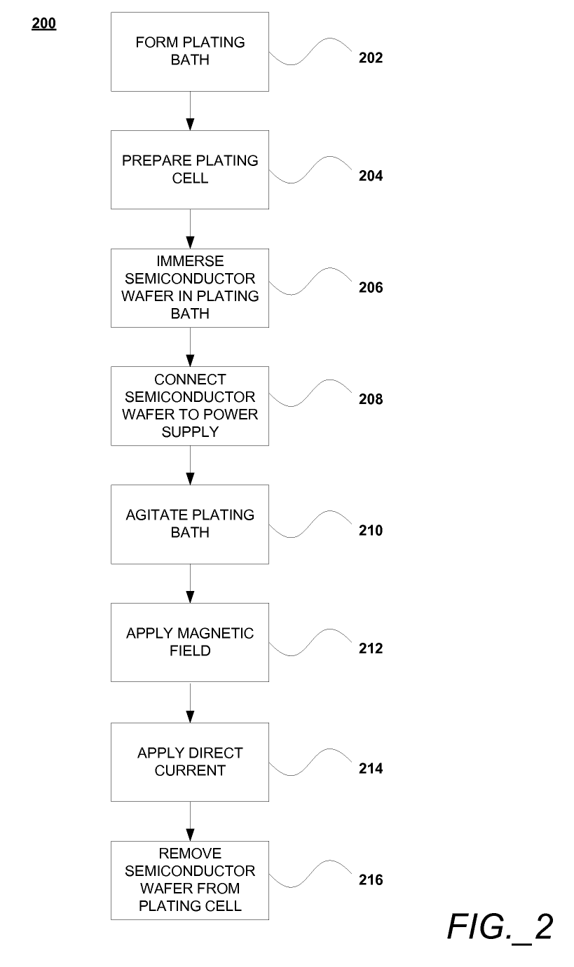

FIG. 2 is a method 200 of performing a hybrid electro-deposition process in accordance with an implementation of the invention. The method 200 begins with the forming of a cobalt plating bath for use in the hybrid electro-deposition process (process 202 of FIG. 2). The constituents of such a plating bath were provided above. A plating cell is then prepared using the plating bath (204). As described above, the plating cell includes a reactor that holds the plating bath, as well as an anode, an agitator, and a DC power supply.

Next, a substrate is immersed into the plating bath (206). The substrate functions as a cathode in the electro-deposition process of the invention and provides a surface upon which the soft magnetic cobalt alloy film will be formed. In some implementations, the substrate may be a semiconductor wafer. In various implementations, the semiconductor substrate may be formed using a bulk silicon or a silicon-on-insulator substructure. In other implementations, the substrate may be formed using alternate materials, which may or may not be combined with silicon, that include but are not limited to germanium, indium antimonide, lead telluride, indium arsenide, indium phosphide, gallium arsenide, gallium antimonide, or other Group III-V materials. Although a few examples of materials from which the semiconductor substrate may be formed are described here, any material that may serve as a foundation upon which a semiconductor device may be built falls within the spirit and scope of the present invention.

In further implementations, the substrate may have at least one dielectric layer deposited on its surface. The dielectric layer may be formed using materials known for the applicability in dielectric layers for integrated circuit structures, such as low-k dielectric materials. Such dielectric materials include, but are not limited to, silicon dioxide (SiO₂), carbon doped oxide (CDO), silicon nitride, organic polymers such as perfluorocyclobutane or polytetrafluoroethylene, fluorosilicate glass (FSG), and organosilicates such as silsesquioxane, siloxane, or organosilicate glass. The dielectric layer may include pores or other voids to further reduce its dielectric constant.

The substrate, such as the semiconductor wafer, is connected to the negative terminal of the power supply to function as a cathode (208). This connection may be formed either before or after the substrate is immersed into the plating bath. Furthermore, during the electro-deposition process, the agitator is used to agitate the plating bath (210). The rotational speed of the agitator is not critically important to the deposition process, but in some implementations, the agitator may rotate at a speed that ranges from 200 RPM to 800 RPM.

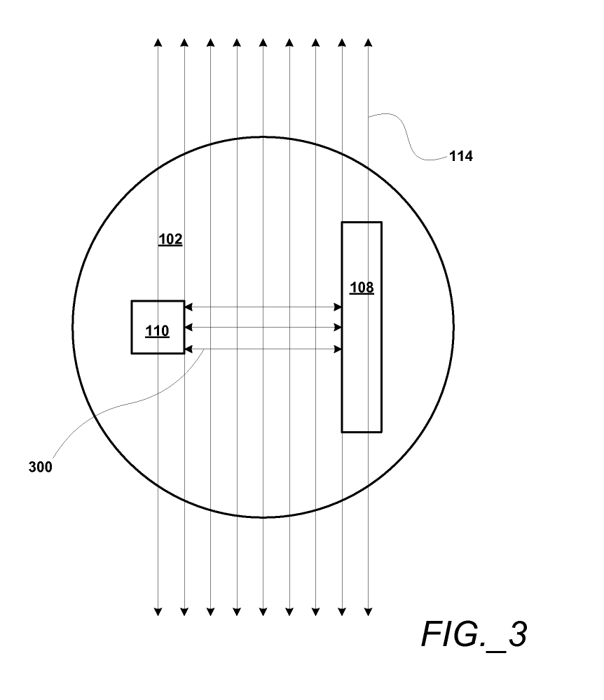

A magnetic field is applied across the plating cell (212). In some implementations, the magnetic field may be generated using permanent magnets or electromagnets. In accordance with implementations of the invention, the magnetic field is aligned in a direction that is perpendicular to the electrical current direction and is parallel to the plane of the substrate. This is shown in FIG. 1 by magnetic field lines 114. FIG. 3 is a top down view of the reactor 102 that illustrates how the magnetic field lines 114 are perpendicular to electric field lines 300. As shown, the electric field lines 300 develop between the anode 110 and the cathode (semiconductor wafer) 108.

Finally, the DC power supply is turned on to provide an electrical current to the plating cell and cause the electro-deposition process to occur (214). The application of the DC current establishes a current density that is between around 5 mA/cm² to around 30 mA/cm².

As will be known to those of ordinary skill in the art, the electron flow from the DC power supply causes cobalt and other alloy metal components (e.g., nickel or iron) to become reduced and plate onto the cathode surface (i.e., the substrate surface). This occurs with the plating bath at room temperature. In some implementations of the invention, the temperature of the plating bath may be elevated above room temperature to cause electrons to be released from the reducing agent in the plating bath as well. This results in boron being integrated into the plated cobalt alloy film. This elevated temperature may be above room temperature but is still below temperatures used in conventional electroless plating processes.

The hybrid electro-deposition process continues until the deposited soft magnetic film has reached a desired level of thickness. In some implementations, this thickness may range from around 1 μm to around 10 μm. After the soft magnetic film has reached the desired level of thickness, the DC power supply may be turned off to halt the current flow and the substrate may be removed from the plating cell (216). In various implementations of the invention, to achieve the desired thickness, the hybrid electro-deposition process of the invention may be carried out for a time period that lasts from around 1 second to around 20 minutes. As will be appreciated by those of skill in the art, the time period will vary greatly depending on the deposition rate of soft magnetic film and the desired thickness, so time periods of greater than 20 minutes fall within the scope of this invention.

In accordance with implementations of the invention, the end result of this hybrid electro-deposition process under the influence of the magnetic field is a soft magnetic cobalt alloy film becoming deposited onto the substrate. The hybrid electro-deposition process of the invention provides advantages over conventional electroless processes that make it suitable for use in high volume manufacturing processes. For example, since an external DC power supply is used, the plating rate is relatively higher than conventional electroless plating processes. In some implementations, the plating rate may increase by 250% or more using implementations of the invention. A higher plating rate enables thicker films to be produced in less time.

Furthermore, since the plating bath can be operated at room temperature or at temperatures below the temperature required by conventional electroless plating processes, the plating bath has increased stability and increased lifetime. For instance, while conventional electroless plating processes require plating bath temperatures in excess of 60° C., the hybrid electro-deposition process of the invention requires temperatures that range between around 22° C. and around 40° C. It has been shown that the lifetime of the plating bath may increase by a factor of three due to the reduced operating temperature.

Accordingly, a hybrid electro-deposition process has been described that uses an electroless plating bath for cobalt metal in an electroplating process under the influence of an external magnetic field. The electroplating process uses a cobalt-containing anode and a semiconductor wafer as a cathode. The magnetic field is aligned perpendicular to the electric field. The result is the deposition of a soft cobalt-containing magnetic film on the semiconductor wafer.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
providing a plating bath that includes a metal and a reducing agent;
providing an anode in the plating bath coupled to a power supply;
providing a substrate in the plating bath coupled to the power supply, wherein the substrate functions as a cathode;
applying a magnetic field across the plating bath; and
applying an electrical current to the plating bath by way of the power supply to cause the metal to deposit onto the substrate and form a soft magnetic film.

2. The method of claim 1, wherein the plating bath comprises water, a cobalt salt, DMAB, and at least one of citrate or acetate.

3. The method of claim 2, wherein the plating bath further comprises at least one boron, tungsten, iron, nickel, and ammonium hypophosphite.

4. The method of claim 1, further comprising agitating the plating bath.

5. The method of claim 1, wherein the metal comprises cobalt.

6. The method of claim 5, wherein the anode comprises at least one metal selected from the group consisting of cobalt, iron, nickel, and platinized titanium.

7. The method of claim 1, wherein the substrate comprises a semiconductor wafer.

8. The method of claim 1, wherein the magnetic field is applied in a direction that is perpendicular to the direction of an electric field generated by the electrical current.

9. The method of claim 1, further comprising maintaining the plating bath at a temperature between around 22° C. and around 40° C.

10. The method of claim 1, wherein the electrical current is applied until the soft magnetic film has a thickness between around 1 μm to around 10 μm.

11. A plating cell comprising:
a reactor;
a plating bath within the reactor, wherein the plating bath comprises a metal and a reducing agent;
an agitator at least partially within the reactor to agitate the plating bath;
a semiconductor wafer immersed in the plating bath;
an anode immersed in the plating bath;
a power supply electrically coupled to the semiconductor wafer and the anode; and
a magnetic field source to provide a magnetic field across the plating cell.

12. The plating cell of claim 11, wherein the plating bath comprises water, cobalt, DMAB, and at least one of citrate or acetate.

13. The plating cell of claim 11, wherein the anode comprises at least one metal selected from the group consisting of cobalt, iron, nickel, and platinized titanium.

14. The plating cell of claim 11, wherein the power supply is an external DC power supply that establishes a current density that is between around 5 mA/cm² to around 30 mA/cm².

15. The plating cell of claim 11, wherein the magnetic field source comprises a permanent magnet or an electromagnet.
